(19) United States
(12) Patent Application Publication
(10) Pub. No.: US 2004/0239776 A1
(43) Pub. Date: Dec. 2, 2004

(54) Automatic photographing system

(75) Inventors: Mamoru Shinohara, Kanagawa-ken (JP); Yoichi Nakamura, Kanagawa-ken (JP); Hiroshi Yamaguchi, Kanagawa-ken (JP); Jun Enomoto, Kanagawa-ken (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 10/850,368

(22) Filed: May 21, 2004

(30) Foreign Application Priority Data
May 27, 2003 (JP) 148529/2003

(51) Int. Cl. H04N 5/262

(52) U.S. Cl. 348/239

(57) ABSTRACT

A photographing control device controls an imaging device so that the imaging device obtains a still image of a subject when a movement analyzing device judges that the subject has become still.

### BACKGROUND OF THE INVENTION

1. Field of the Invention

The present invention relates to an automatic photographing system for automatically photographing a subject.

2. Description of the Related Art

An automatic photographing system installed at a predetermined place in entertainment facilities such as a theme park and an amusement park is known, wherein photographs are intermittently taken by a photographing device of which the shutter can be automatically released (refer to Japanese Unexamined Patent Publication No. 11(1999)-136607, for example). Photographs had conventionally been taken by a photographer who holds a camera. However, photographs are automatically taken by an installed camera in this system.

A method is proposed, wherein a camera is installed at a predetermined place in a theme park and a memorial photograph or the like is taken by the camera. In the case that the photographs are taken by the installed camera, a method is proposed, wherein a visitor carries an operation unit which can communicate with the camera and the visitor operates a shutter by operating the operation unit at the time of photography. A method is also proposed, wherein a photograph is taken when a subject has entered a specific photographing area within a fixed distance from an imaging device (refer to U.S. Patent Laid-Open No. 20020049728, for example).

However, in the method wherein the visitor operates the operation unit for operating the shutter, the photographs are taken while the subject is operating the operation unit. Therefore, there is a problem that the poses of the subject tend to be limited. Further, it is difficult to obtain an image of the visitor posing in a manner that he/she desires.

Further, in the method wherein the shutter is released when the user has entered the specific photographing area, it is difficult for him/her to know the timing of photographing. Therefore, even if the user desires to pose to be photographed, he/she is photographed before posing, for example. Consequently, there is a problem that the user does not always obtain the best shot that he/she desires.

There is also a method wherein an imaging device 10 intermittently takes photographs at a constant intervals and a visitor selects an image which he/she likes from the photographs which have been taken. However, since a huge number of unnecessary images is stored in a server for storing the images, the load on the server for storing the images becomes high.

### SUMMARY OF THE INVENTION

In view of the foregoing circumstances, it is an object of the present invention to provide an automatic photographing system, wherein photographs are automatically taken at a timing that a user desires.

An automatic photographing system according to the present invention includes an imaging device, a subject identifying device for identifying a subject who is to be photographed by the imaging device, a movement analyzing device for analyzing a movement of the subject identified by the subject identifying device, and a photographing control device for controlling the imaging device, wherein the photographing control device controls the imaging device so that the imaging device obtains a still image of the subject when the movement analyzing device judges that the subject has become still.

The “movement analyzing device” is a device for analyzing the movement of the subject. The “movement analyzing device” may be a device for analyzing the movement of the subject by analyzing images which have been continuously imaged by the imaging device, for example. Alternatively, the “movement analyzing device” may be a device for analyzing the movement of the subject by using a sensor or the like for directly detecting the movement of the subject.

Further, the state that “the subject has become still” includes the state that the subject moves within the vicinity of a stopped position, e.g., moving his/her face to assume a facial expression or moving his/her arms and legs to assume a pose to be photographed in, in addition to a state that the subject stops at a fixed position and does not move.

The photographing control device may control the imaging device so that the imaging device immediately starts photographing when the movement analyzing device judges that the subject has become still. Alternatively, the photographing control device may control the imaging device so that the imaging device photographs after the movement analyzing device judges that a predetermined waiting time has passed after the subject has become still.

The photographing control device may further include a passage time notifying means such as a speaker and a display device, for notifying the subject of passage of the waiting time by a countdown.

A device for obtaining a still image by photographing the subject may be used as the imaging device. The imaging device may also include a camera and a swing means for swinging the camera.

The camera may also include a follow camera for obtaining a dynamic image by following the subject and a photographing camera for obtaining the still image of the subject.

The photographing control device may further include a subject following means for controlling the swing means so that the camera follows the subject when the movement analyzing device judges that the subject is moving.

In the automatic photographing system according to the present invention, when the movement analyzing device judges that the subject has become still, the photographing control device controls the imaging device so that the imaging device obtains the still image of the subject. Therefore, when photographs are automatically taken, the subject can set a shutter timing without operating a shutter button or the like by him/herself. Accordingly, when the subject is photographed, the pose of the subject is not limited and a best shot of the subject posing in a manner that he/she desires can be obtained.

Further, even in the case that the photographing control device controls the imaging device so that the imaging device obtains a still image of the subject when the movement analyzing device judges that the subject has become still and photographs are automatically taken, the shutter timing is determined by the movement of the subject. Therefore, the photographs can be taken with a timing that the subject desires. Consequently, the number of photographic images, which are unnecessary for the subject, can be decreased and the load on the server for storing the photographed images can be reduced.

If the photographing control device controls the imaging device so that the imaging device photographs after the movement analyzing device judges that the predetermined waiting time has passed after the subject has become still, time for posing and time for judging whether or not a photograph should be taken may be given to the subject. Therefore, an image of the subject posing in a manner that he/she desires can be obtained.

Further, if the photographing control device further includes a passage time notifying means for notifying the subject of the passage of the waiting time by a countdown, the photographing control device can notify the subject of the time remaining until photographing. Therefore, the subject can get ready for photographing during the waiting time while he/she is checking the time until photographing starts.

Further, if the imaging device includes a camera and a swing means for swinging the camera and the photographing control device includes a subject following means for controlling the swing means so that the camera follows the subject when the movement analyzing device judges that the subject is moving, the subject can be automatically photographed without fail even if he/she moves.

Further, if the camera includes a follow camera for obtaining a dynamic image by following the subject and a photographing camera for obtaining the still image of the subject, an image which is appropriate for analyzing the movement of the subject and a high quality image which will be provided to the subject as a print or the like can be obtained. Therefore, accuracy in following the subject can be improved and the quality of the still image can be improved.

### BRIEF DESCRIPTION OF THE DRAWINGS

FIG. 1 shows a schematic view illustrating a preferred embodiment of an automatic photographing system according to the present invention;

FIG. 2 shows a schematic view illustrating a preferred embodiment of an automatic photographing system according to the present invention;

FIG. 3 shows a schematic view illustrating an example of an imaging device in an automatic photographing system of FIG. 1;

FIG. 4 shows a block diagram illustrating a preferred embodiment of an automatic photographing system according to the present invention; and

FIG. 5 shows a flow chart illustrating an example of operation of an automatic photographing system according to the present invention.

### DESCRIPTION OF THE PREFERRED EMBODIMENTS

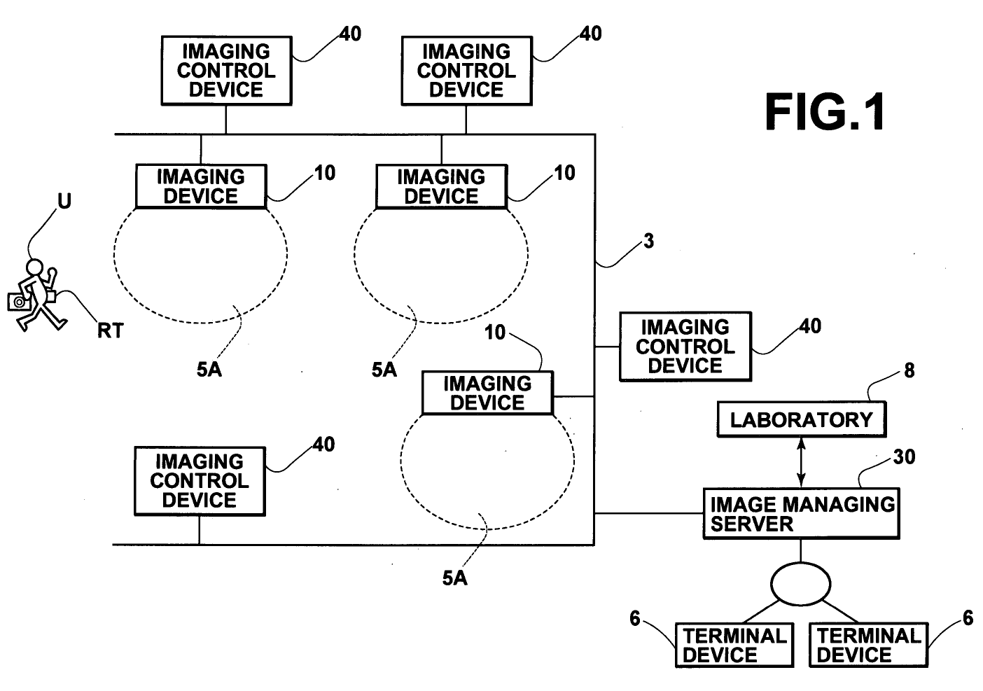

Hereinafter, embodiments of an automatic photographing system according to the present invention will be described with reference drawings. FIG. 1 shows a schematic view illustrating an example wherein a preferred embodiment of the automatic photographing system according to the present invention is employed. An automatic photographing system 1 illustrated in FIG. 1 is installed in a theme park, an amusement park or the like, for example. Each automatic photographing system 1 illustrated in FIG. 1 includes a plurality of imaging devices 10 for photographing a visitor (subject) U in the theme park and obtaining images of the subject, an image managing server 30 for managing the images obtained by the imaging devices and a photographing control device 40 for controlling an operation of each of the imaging devices 10. The plurality of imaging devices 10, the image managing server 30 and the photographing control device 40 can transfer data each other via a network 3 such as a LAN.

FIG. 1 illustrates a case wherein the photographing control device 40 is provided in each of the imaging devices 10. However, a single photographing control device 40 may control operations of the plurality of imaging devices 10 via the network 3. Further, FIG. 1 illustrates a case wherein the photographing control device 40 is configured by a computer which is independent of each of the imaging devices 10 or the image managing server 30. However, the photographing control device 40 may be provided in each of the imaging devices 10. Alternatively, the photographing control device 40 may be provided in the image managing server 30.

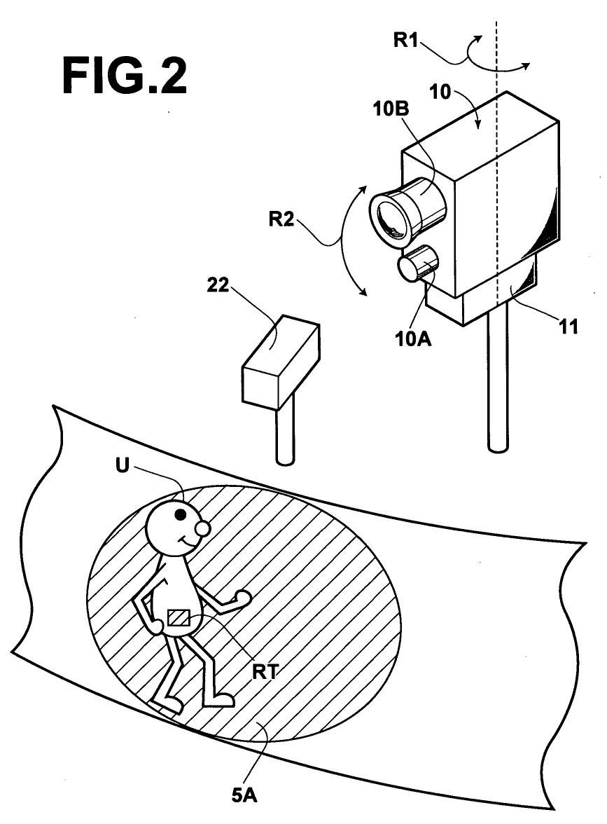

Here, each of the imaging devices 10 photographs the subject U who is present in a photographing area 5A of each of the imaging devices 10. Specifically, the imaging device 10 is fixed at a fixed position as illustrated in FIG. 2. The imaging device 10 includes a follow camera 10A for photographing a dynamic image to follow a subject U who is moving, a photographing camera 10B for obtaining a still image by photographing the subject U and a swing means 11 for swinging the follow camera 10A and the photographing camera 10B in a horizontal direction R1 and a vertical direction R2. The swing means 11 is a two-axis actuator which can swing in the horizontal direction and the vertical direction with respect to two axes respectively, for example. When the swing means 11 operates, the photographing camera 10B and the follow camera 10A swing in a unified manner and photograph the subject U in the photographing area 5A.

The image managing server 30 in FIG. 1 manages the images obtained by the imaging device 10. The image managing server 30 also has a function of enabling the system to provide the images in prints or the like for the visitor U who was the subject.

The image managing server 30 may output the images obtained by photography as prints or the like, after performing the processing for improving the quality, such as off-set correction and shading correction. The image managing server 30 has a function of printing out the obtained images to distribute the prints to the visitors U when the visitors U go home. The image managing server 30 may also have a function of transmitting the images obtained by the imaging device 10 so that the images are printed out at a laboratory 8 for example or providing the images stored in an information recording medium such as a floppy disk, a memory card, or the like for the visitor U. Further, the image managing server 30 may also have a function of distributing the images to a terminal device 6 at the home of each visitor U via the Internet or the like.

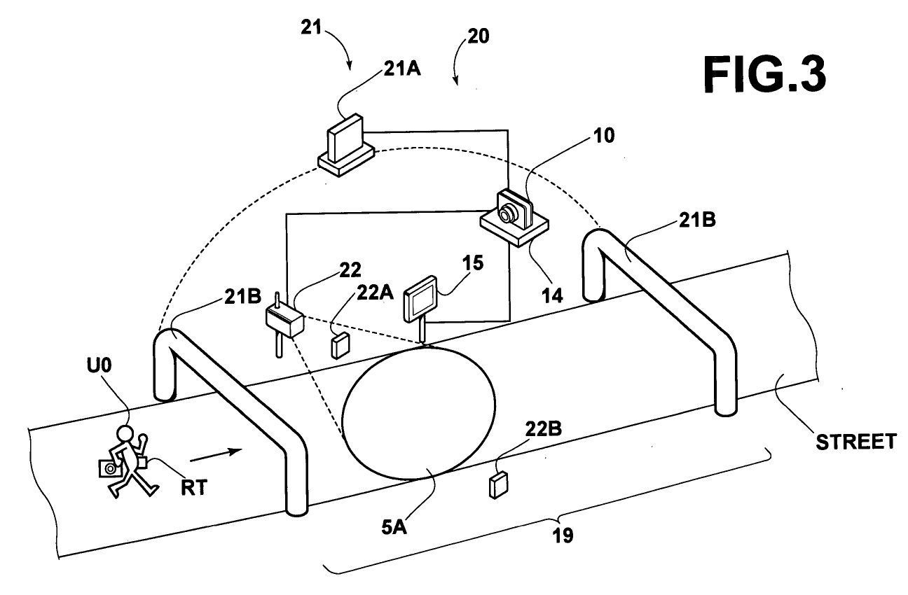

FIG. 3 shows a schematic view illustrating the vicinity of the imaging device 10 in the automatic photographing system 1. A subject identifying device 20 for identifying the subject U which should be photographed by the imaging device 10 is provided in the vicinity of the photographing area 5A of the imaging device 10 in FIG. 3. The subject identifying device 20 identifies the subject U by receiving a signal from a transmitter RT (wireless tag) carried by the visitor U.

Here, an IC card type device such as a non-contact type (wireless) IC card, which can transmit/receive or only transmit, or a non-contact ID card with a built-in battery and a non-contact ID card of an electromagnetic induction type (without power supply), which can transmit/receive or only transmit are used as the transmitter RT. A wireless tag (RFID: Radio Frequency Identification) of the long distance type (communication range is approximately several meters) is also used as the transmitter RT. A subject ID for identifying the properties of the visitor U is stored in the transmitter RT and the subject ID is transmitted from the transmitter RT. A different subject ID may be provided to each user or the same ID information may be provided to members of a group such as a family, a pair of persons such as a couple, and friends. Accordingly, even if the user him/herself is not in photograph images, the user can obtain the photographs including other users within his/her group or a child in his/her family.

Further, the subject identifying device 20 also includes a wide-area detecting means 21 for detecting that the visitor U has entered a wide area 19 and a photographing area detecting means 22 for detecting that the visitor U has entered the photographing area 5A. The wide-area detecting means 21 includes a wide-area antenna 21A and gates 21B and 21B.

The wide-area antenna 21A is a wireless receiver which can communicate with the transmitters RT in the wide area 19. The wide-area antenna 21A obtains the congestion condition of the photographing area 5A by detecting the transmitters RT and counting the number of the transmitters RT. The gates 21B and 21B have a function of counting a number of the transmitters RT by detecting the signals from the transmitters RT. The gates 21B and 21B also have a function of counting the visitors U who are not carrying the transmitters RT by using an infrared ray sensor or the like. The gates 21B and 21B are used for predicting a number of persons going to the photographing area 5A.

The photographing area detecting means 22 is a receiver of which communication range is the photographing area 5A. The photographing area detecting means 22 receives a subject ID from a transmitter RT which has entered the photographing area 5A and identifies the subject U. The photographing area detecting means 22 sends the detected subject ID to the image managing server 30 (refer to FIG. 1) and the image managing server 30 stores the subject ID and images photographed by the imaging device 10 by relating them. Accordingly, the photograph images of the visitor U can be retrieved by using the subject ID stored in the transmitter carried by the visitor U as a retrieval key and the images can be provided to the visitor U.

The photographing area detecting means 22 may further include an ultrasonic sensor 22A and an infrared sensor 22B for assisting pan/tilt control at the imaging device 10 and detect a position of the subject U in the photographing area 5A.

A display unit 15 such as a CRT, a liquid crystal display or the like is installed in the vicinity of the photographing area 5A in the automatic photographing system 1 in FIG. 3. The display unit 15 displays information for the subject U that a photograph of the subject U will be taken. The display unit 15 also displays a preview of the photographed image for the subject U.

Next, an example of an operation of the automatic photographing system 1 will be described with reference to FIGS. 1-3. First, when the visitor U carrying the transmitter RT enters the wide area 19, the wide-area detecting means 21 detects the subject ID transmitted from the transmitter RT as illustrated in FIG. 3. Then, the image managing server 30 predicts a number of visitors U who will enter the photographing area 5A provided in the wide area 19 and judges whether or not circumstances are appropriate for photographing.

If the subject U enters the photographing area 5A in the circumstance which is judged as the appropriate condition for photographing, the photographing area detecting means 22 detects the subject ID transmitted from the transmitter RT. Then, the imaging device 10 automatically photographs the subject U according to an instruction from the photographing control device 40 and an image obtained by the imaging device 10 is transmitted to the image managing server 30 via the network 3. The image managing server 30 performs predetermined image processing for improving the quality of the image and stores the image and the subject ID by relating them. When the visitor U goes home, the photograph image of the visitor U is retrieved from the image managing server 30 by using the subject ID stored in the transmitter RT as a retrieval key. The retrieved image is provided to the visitor.

In the above-mentioned automatic photographing system 1, timing of photographing by the imaging device 10 is important. As described above, in the case that the visitor U operates an operation unit for controlling the imaging device 10 to take a photograph, the visitor U can take the photograph with a timing that he/she desires. However, since the visitor U needs to hold the operation unit in his/her hands, poses of the visitor U tend to be limited. Further, in a method of photographing, wherein a photograph is taken when the subject has entered a specified photographing area, it is difficult for the user to know when the photograph will be taken. Even if the user desires to assume a pose to be photographed, the user is photographed before posing, for example. Hence, there is a problem that the user does not always obtain the best shot that he/she desires.

Specifically, even in the case that photographs are automatically taken, the visitor desires to be photographed while he/she is posing that he/she desires. Therefore, the photographing control device 40 is configured as will be described below and the shutter timing is controlled in the automatic photographing system 1.

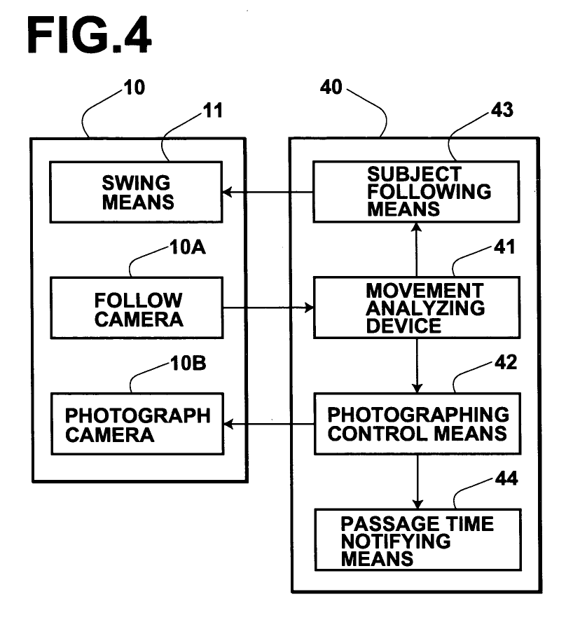

FIG. 4 shows a block diagram illustrating a preferred embodiment of the photographing control device 40 in the automatic photographing system 1. The photographing control device 40 includes a movement analyzing device 41 for analyzing a movement of the subject U, a photographing control means 42 for controlling photographing timing of the imaging device 10 and a subject following means 43 for causing the imaging device 10 to follow the subject U when he/she is moving.

The movement analyzing device 41 includes a function of analyzing the movement of the subject U based on a dynamic image obtained by the follow camera 10A. Specifically, the movement analyzing device 41 analyzes the movement of the subject U by using known techniques such as a background difference method wherein the subject U is detected by creating a background image and performing difference processing on the background image with a present image, a frame difference method wherein a movement of the subject U is detected by performing difference processing between two images which have been photographed at a time interval of N frames (N is an integer which is one or greater), a space differential method wherein an area with a high brightness gradient is detected from an image and the subject U is detected based on the detected information or a combination of these methods.

Further, the movement analyzing device 41 judges whether the subject U is moving or still based on the result of analyzing the movement of the subject U. The movement analyzing device 41 judges that the subject U is still if the subject U stops at a fixed position and does not move. The movement analyzing device 41 may also judge that the subject U is still even if he/she is moving within the vicinity of a position where he/she has stopped, e.g., moving his/her face or his/her arms and legs to assume a pose to be photographed.

The photographing control means 42 controls the photographing camera 10B of the imaging device 10 so that the photographing camera 10B obtains a still image of the subject U when the movement analyzing device 41 judges that the subject U has become still. Specifically, if the subject U desires to photograph, the subject only needs to become still in the photographing area 5A. Therefore, the photographing timing can be determined by the subject U, and the subject U can obtain his/her image posing in a manner that he/she desires. Further, the subject U can freely select a background of the image or the like in the photographing area 5A by changing a position where he/she becomes still in the photographing area 5A. Therefore, an image of the user who is posing in a manner that he/she desires with a background which he/she desires can be obtained.

Further, the photographing control means 42 photographs after a set waiting time (five seconds, for example) has passed after the movement analyzing device 41 judges that the subject U has become still. Accordingly, the subject U can get ready for photographing during the waiting time and a photograph of the subject U who is posing in the manner that he/she desires or the like can be taken. Further, a passage time notifying means 44 such as the display unit 15, a speaker or the like outputs information on the passage of the waiting time by a countdown. Accordingly, the visitor U who is the subject U is enabled to check the waiting time while he/she is getting ready to be photographed. Hence, the subject U who is posing in the manner that he/she desires can be photographed without fail.

Further, the movement analyzing device 41 includes a function of analyzing the movement of the subject U also during the waiting time. The photographing control means 42 controls the system so that photographing is cancelled when the movement analyzing device 41 judges that the subject U has moved during the waiting time. Specifically, if the subject U desires to cancel photographing, the subject U only needs to move from the place. Hence, cancellation of photographing can be also controlled by the subject U.

The subject following means 43 includes a function of controlling the swing means 11 so that the follow camera 10A follows the subject U when the movement analyzing device 41 judges that the subject U is moving (refer to FIG. 3). Specifically, if the subject U moves to an upper left side in an image photographed by the follow camera 10A, the subject following means 43 causes the swing means 11 to operate so that a field of view (photographing range) of the follow camera 10A is moved toward the upper left side. Then, the photographing camera 10B swings in a unified manner with the follow camera 10A and the subject U comes to exist also in the field of view (photographing range) of the photographing camera 10B. Consequently, the still image of the subject U can be obtained.

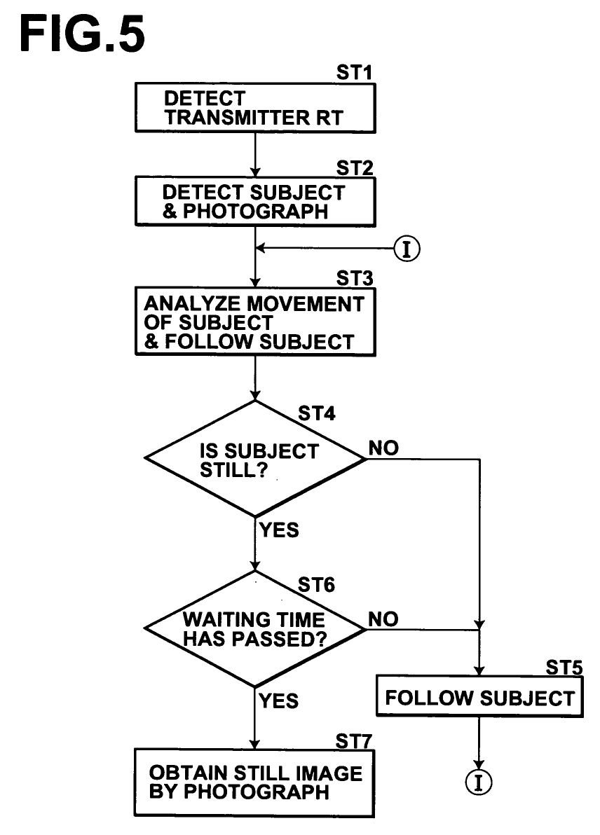

FIG. 5 shows a flow chart illustrating an example of operation of the automatic photographing system 1. An example of the operation of the automatic photographing system 1 will be described with reference to FIGS. 1-5. First, when the subject U enters the photographing area 5A in FIG. 1, the subject identifying device 20 identifies the subject U (step ST1). Then, the subject U who has been identified by the subject identifying device 20 is photographed by the follow camera 10A (step ST2) and the movement analyzing device 41 analyzes the movement of the subject U based on a dynamic image photographed by the follow camera 10A (step ST3).

When the movement analyzing device 41 judges that the subject U is moving (step ST4), the field of view (photographing range) of the imaging device 10 is moved by the swing means 11 according to the movement of the subject U and the movement analyzing device 41 follows the subject U (step ST5). If the subject U has moved outside of the range of the photographing area 5A, the subject identifying device 20 judges that the subject U has moved outside the photographing area 5A and the movement analyzing device 41 stops following the subject U. When the subject identifying device 20 identifies another subject U, the movement analyzing device 41 starts to analyze the movement of the new subject U.

Meanwhile, when the movement analyzing device 41 judges that the subject U has become still (step ST4), the movement analyzing device 41 judges if the waiting time has passed after the subject U has become still (step ST6). At this time, the passage time notifying means 44 notifies the visitor U of the passage of the waiting time by a countdown. The movement of the subject is analyzed by the movement analyzing device 41 even during the waiting time. If the subject U moves during the waiting time, the photograph is not taken and the subject U begins to be followed (step ST5).

Then, when the waiting time has passed after the subject U has become still (step ST6), the photographing control means 42 instructs the photographing camera 10B to photograph and the photographing camera 10B obtains a still image (step ST7).

According to the above-described embodiment, the photographing control device 40 controls the imaging device 10 so that the imaging device 10 obtains the still image of the subject U when the movement analyzing device 41 judges that the subject U has become still in the automatic photographing system of the present invention. Therefore, when the photograph is automatically taken, the shutter timing can be set by the subject him/herself without operating a shutter button. Accordingly, when the subject U is photographed, a pose of the subject U is not limited and a best shot posing in a manner that he/she desires can be obtained.

Even if the photographing control device 40 controls the imaging device 10 so that the imaging device 10 obtains a still image of the subject U when the movement analyzing device 41 judges that the subject U has become still and the photograph is automatically taken, shutter timing may be determined by the movement of the subject U. Therefore, the photographs can be taken with a timing that the subject U desires.

Further, if the photographing control device 40 controls the imaging device 10 so that the imaging device 10 photographs after the movement analyzing device 41 judges that predetermined waiting time has passed after the subject U has become still, time for posing and time for judging if a photograph should be taken can be given to the subject U. Therefore, an image of the subject U posing in a manner that he/she desires can be obtained.

If the photographing control device 40 further includes the passage time notifying means 44 for notifying the subject U of passage of waiting time by a countdown, the photographing control device 40 can notify the subject U of time till photographing. Therefore, the subject U can get ready for photographing during the waiting time while he/she is checking the time till photographing starts.

Further, if the imaging device 10 includes the cameras 10A and 10B and the swing means 11 for swinging the cameras and the photographing control device 40 includes the subject following means 43 for controlling the swing means 11 so that the camera follows the subject U when the movement analyzing device 41 judges that the subject U is moving, the subject U can be automatically photographed without fail even if the subject U moves.

If the cameras include the follow camera 10A for obtaining a dynamic image by following the subject U and the photographing camera 10B for obtaining the still image of the subject t, an image appropriate for analyzing the movement of the subject U and a high quality image to be provided to the subject U as a print or the like can be obtained. Therefore, accuracy in following the subject U can be improved and the quality of the still image can be improved.

The present invention is not limited to the above-mentioned embodiment. FIG. 3 illustrates a case wherein the follow camera 10A and the photographing camera 10B are provided in the imaging device 10, for example. Alternatively, only the photographing camera 10B may be provided in the imaging device 10. In the case that only the photographing camera 10B is provided, photographs are taken by the photographing camera 10B at constant intervals and the movement of the subject U is analyzed by comparing the images obtained by photographing. An image of the subject U, which was obtained when he/she was still may be also stored.

In the case that the imaging device 10 analyzes the movement of the subject, the images photographed by the imaging device 10 is used to analyze the movement. The position of the subject U in the photographing area 5A may be identified by the subject identifying device 20 and the imaging device 10 may be moved so that the identified position is photographed. Specifically, a person detecting sensor may be provided in the photographing area 5A and the movement of the subject U may be analyzed by detecting the positions of the subject U in the photographing area 5A in temporal series based on signals received from the person detecting sensor. Further, the subject following means 43 may control the imaging device 10 so that the imaging device 10 points to the position where the subject U is present, based on an output from the person detecting sensor.

In the above-mentioned embodiment, a case wherein the automatic photographing system 1 is installed in a theme park, an amusement park or the like was illustrated. However, the automatic photographing system 1 may be applied to a fixed point camera such as a security camera in a building, for example. In FIG. 2, the subject identifying device 20 identifies the subject U by detecting the transmitter RT. However, the subject U may be identified by extracting the properties of the subject U from a dynamic image photographed by the follow camera 10A and a still image may be also obtained when the subject U becomes still.

What is claimed is:

1. An automatic photographing system comprising:
an imaging device;
a subject identifying device for identifying a subject who should be photographed by the imaging device;
a movement analyzing device for analyzing a movement of the subject identified by the subject identifying device; and
a photographing control device for controlling the imaging device, wherein the photographing control device controls the imaging device so that the imaging device obtains a still image of the subject when the movement analyzing device judges that the subject has become still.

2. An automatic photographing system as defined in claim 1, wherein the photographing control device controls the imaging device so that the imaging device photographs the subject after the movement analyzing device judges that a predetermined waiting time has passed after the subject has become still.

3. An automatic photographing system as defined in claim 1, wherein the photographing control device further includes a passage time notifying means for notifying the subject of passage of a waiting time by a countdown.

4. An automatic photographing system as defined in claim 1, wherein the imaging device includes a camera and a swing means for swinging the camera, wherein the photographing control device includes a subject following means for controlling the swing means so that the camera follows the subject when the movement analyzing device judges that the subject is moving.

5. An automatic photographing system as defined in claim 4, wherein the swing means is a two-axis actuator.

6. An automatic photographing system as defined in claim 4, wherein the camera includes a follow camera for obtaining a dynamic image by following the subject and a photographing camera for obtaining the still image of the subject.
